(19) United States
(12) Patent Application Publication
(10) Pub. No.: US 2024/0255989 A1
(43) Pub. Date: Aug. 1, 2024

(54) HEAD MOUNTED DEVICE

(71) Applicant: Sony Group Corporation, Tokyo (JP)

(72) Inventors: Toshimi KOBAYASHI, Kanagawa (JP); Takaaki YOSHIDA, Kanagawa (JP)

(73) Assignee: Sony Group Corporation, Tokyo (JP)

(21) Appl. No.: 18/290,632

(22) PCT Filed: Mar. 1, 2022
(86) PCT No.: PCT/JP2022/008488

§ 371 Date: Jan. 19, 2024

(30) Foreign Application Priority Data
Jul. 26, 2021 (JP) 2021-121700

(51) Int. Cl. G06F 1/16

(52) U.S. Cl. CPC G06F 1/163

(57) ABSTRACT

The present technology relates to a head mounted device that is mounted on a head of a user using a temple so as to realize more comfortable mounting. The head mounted display includes two temples mounted on the head of the user. The temples include two stages of parallel link mechanisms including a first link and a second link parallel to each other, and a third link and a fourth link parallel to each other. In the parallel link mechanisms of two consecutive stages, the second link of a preceding parallel link mechanism and the first link of a subsequent parallel link mechanism are shared, and in a case where the parallel link mechanism of the preceding stage comes into contact with the head, the parallel link mechanism of the subsequent stage rotates with respect to the parallel link mechanism of the preceding stage. The present technology can be applied to, for example, a head mounted display, and the like.

### TECHNICAL FIELD

The present technology relates to a head mounted device, and more particularly to a head mounted device that is mounted on a head of a user using a temple so as to realize more comfortable mounting.

### BACKGROUND ART

As a mounting mechanism of a head mounted display (HMD), there are a mechanism for holding a display by sandwiching a frontal region and an occipital region through a pad, and a mechanism for holding the display by mounting a temple on a head similarly to general glasses.

In the former mechanism, mounting is relatively stable, but the user has to wear the HMD so as to receive the HMD from above the head, which is difficult to wear (see, for example, Patent Document 1).

The latter mechanism is easy to wear as with glasses, but since the HMD is heavier than general glasses, it is necessary to increase a fastening load that is a load due to fastening of the temple to the head. Here, the temple is basically bilaterally symmetrical, and includes one rod-shaped member. The temple comes into contact with the head at one point from a temporal region to an occipital region due to bending of the member, and generates a fastening load at the one point. Therefore, the fastening load greatly changes depending on a size of the user's head. For example, a user with a small head wears the HMD, and then the fastening load decreases. As a result, wearing becomes loose, and display is easily displaced. On the other hand, a user with a large head wears the HMD, and then the fastening load increases. As a result, wearing becomes tight, and pain due to long-time wearing is likely to occur.

Meanwhile, there is a robot hand having a parallel link (see, for example, Patent Document 2). In this robot hand, a finger plate in a first stage configuring the parallel link rotates and comes into contact with a sphere to be gripped, and then two finger plates in a subsequent stage start to rotate, as a result of which, the sphere is gripped by the three finger plates. Specifically, since a shape of the parallel link formed by the finger plate in the first stage does not change until the finger plate in the first stage comes into contact with the sphere to be gripped, the two finger plates in the subsequent stage do not rotate. After the finger plate in the first stage has come into contact with the sphere to be gripped, an internal angle of the parallel link changes, and the two finger plates in the subsequent stage rotate. In this case, a second finger plate from the beginning may not come into contact with the sphere depending on a position on the sphere to be gripped with which the finger plate in the first stage comes into contact and a size of the sphere.

### CITATION LIST

### Patent Document

Patent Document 1: Japanese Patent Application Laid-Open No. 2021-7254
Patent Document 2: Japanese Patent Application Laid-Open No. 2002-103269

### SUMMARY OF THE INVENTION

### Problems to be Solved by the Invention

As described above, it is desired to realize more comfortable mounting in the head mounted device to be mounted on the head of the user using the temples.

The present technology has been made in view of such a situation, and is intended to realize more comfortable mounting in a head mounted device to be mounted on a head of a user using a temple.

### Solutions to Problems

A head mounted device according to one aspect of the present technology is a head mounted device including two temples to be mounted on a head of a user, in which the temples include a plurality of stages of parallel link mechanisms each including a first link and a second link parallel to each other, and a third link and a fourth link parallel to each other, and in the parallel link mechanisms of two consecutive stages, the second link of the parallel link mechanism in a preceding stage and the first link of the parallel link mechanism in a subsequent stage are shared, and the parallel link mechanism in the subsequent stage rotates with respect to the parallel link mechanism in the preceding stage in a case where the parallel link mechanism in the preceding stage comes into contact with the head.

According to one aspect of the present technology, two temples to be mounted on a head of a user are provided, the temples include a plurality of stages of parallel link mechanisms each including a first link and a second link parallel to each other, and a third link and a fourth link parallel to each other, and in the parallel link mechanisms of two consecutive stages, the second link of the parallel link mechanism in a preceding stage and the first link of the parallel link mechanism in a subsequent stage are shared, and the parallel link mechanism in the subsequent stage rotates with respect to the parallel link mechanism in the preceding stage in a case where the parallel link mechanism in the preceding stage comes into contact with the head.

### BRIEF DESCRIPTION OF DRAWINGS

FIG. 1 is a diagram schematically illustrating an external configuration of an HMD in a first example.

FIG. 2 is a diagram schematically illustrating an external configuration of the HMD in a second example.

FIG. 3 is a diagram schematically illustrating an external configuration example of an HMD according to a first embodiment.

FIG. 4 is a perspective view illustrating a detailed configuration example of the HMD.

FIG. 5 is a perspective view when a temple is disassembled.

FIG. 6 is a plan view when the temple is disassembled.

FIG. 7 is a plan view and a cross-sectional view of the temple.

FIG. 8 is a view of a right-side temple viewed from above.

FIG. 9 is a first diagram illustrating operation of the temple.

FIG. 10 is a second diagram illustrating the operation of the temple.

FIG. 11 is a third diagram illustrating the operation of the temple.

FIG. 12 is a fourth diagram illustrating the operation of the temple.

FIG. 13 is a diagram illustrating a rotation angle of a link.

FIG. 14 is a diagram illustrating a method of setting a main spring and a torsion spring.

FIG. 15 is a diagram illustrating a first example of an actual measurement value of torque.

FIG. 16 is a diagram illustrating a second example of the actual measurement value of torque.

FIG. 17 is a diagram illustrating a third example of the actual measurement value of torque.

FIG. 18 is a diagram illustrating a fourth example of the actual measurement value of torque.

FIG. 19 is a diagram illustrating an external configuration example before mounting an HMD according to a second embodiment.

FIG. 20 is a diagram illustrating an external configuration example after mounting the HMD according to the second embodiment.

FIG. 21 is a diagram illustrating an external configuration example before mounting an HMD according to a third embodiment.

FIG. 22 is a diagram illustrating an external configuration example after mounting the HMD according to the third embodiment.

FIG. 23 is a diagram illustrating an external configuration example of a temple of an HMD according to a fourth embodiment.

FIG. 24 is a diagram illustrating an external configuration example of a temple of an HMD according a fifth embodiment.

FIG. 25 is a diagram illustrating an external configuration example of temples of an HMD according to a sixth embodiment.

FIG. 26 is a perspective view illustrating an external configuration example of a head mounted camera according to a seventh embodiment.

### MODE FOR CARRYING OUT THE INVENTION

A mode for carrying out the present technology (hereinafter, referred to as an embodiment) will be hereinafter described. Note that, a description will be given in the following order.
1. Various HMDs
2. First embodiment (HMD having two parallel link mechanisms)
3. Second embodiment (HMD in which one end of a link portion is positioned lower the other end)
4. Third embodiment (HMD in which a contact surface of a link portion is a curved surface)
5. Fourth embodiment (HMD having main spring adjustment mechanism and torsion spring adjustment mechanism)
6. Fifth embodiment (HMD having a drive unit of a main spring fixing portion)
7. Sixth embodiment (HMD having three parallel link mechanisms)
8. Seventh embodiment (head mounted camera having two parallel link mechanisms)

Note that in the drawings referred to in the following description, the same or similar portions are denoted by the same or similar reference numerals. However, the drawings are schematic, and a relationship between a thickness and a plane dimension, and the like are different from the actual ones. Furthermore, the drawings may include portions having different dimensional relationships and ratios.

Furthermore, definition of directions such as upward and downward directions, and the like in the following description is merely the definition for convenience of description, and does not limit the technical idea of the present disclosure. For example, when an object is observed by rotating the object by 90°, the up and down are converted into and read as left and right, and when the object is observed by rotating the object by 180°, the up and down are inverted and read.

### Examples of Various HMDs

### First Example of HMD

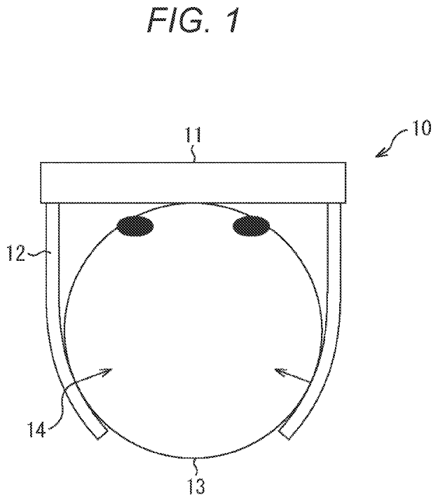

FIG. 1 is a diagram schematically illustrating an external configuration of an HMD in a first example, and is a diagram of a user wearing the HMD as viewed from above.

An HMD 10 in FIG. 1 includes a display 11 and a pair of right and left temples 12. The temple 12 is configured by one rod-shaped member similarly to general glasses. As illustrated in FIG. 1, the HMD 10 is mounted on a head 13 of a user by using the two temples 12. At this time, the temple 12 comes into contact with the head 13 at a point 14 on an occipital region of the head 13. Therefore, a fastening load necessary for holding the display 11 is concentrated on one point 14 on each of the left and right of the head 13. This makes it difficult to realize comfortable mounting. In the temple 12, since the fastening load is generated by the bending of the member, a difference in the fastening load due to a size of the head 13 is large.

### Second Example of HMD

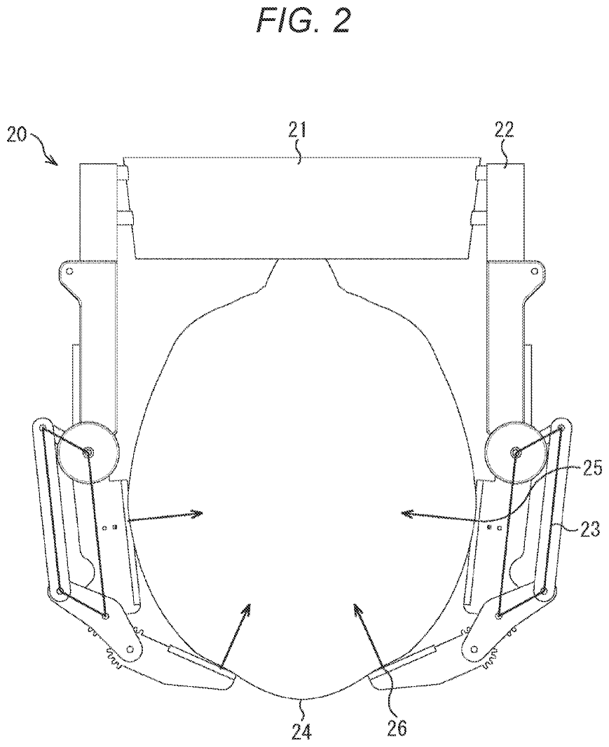

FIG. 2 is a diagram schematically illustrating an external configuration of an HMD in a second example, and is a diagram of the user wearing the HMD as viewed from above.

An HMD 20 in FIG. 2 includes a display 21 and a pair of right and left temples 22. The temple 22 has one parallel link mechanism 23. As illustrated in FIG. 2, the HMD 20 is mounted on a head 24 of the user by using the two temples 22. At this time, the temple 22 comes into contact with the head 24 at two points of a temporal point 25 and an occipital point 26 of the head 24. However, since the heavy display 21 is in front of a frontal region (face), the amount of fastening load at the point 25 on the temporal region contributing to holding of the display 21 is small, which makes it difficult to distribute the fastening load necessary for holding the display 21 to the points 25 and 26. Therefore, the fastening load substantially concentrates on the point 26. This makes it difficult to realize comfortable mounting.

### First Embodiment

### External Configuration Example of HMD

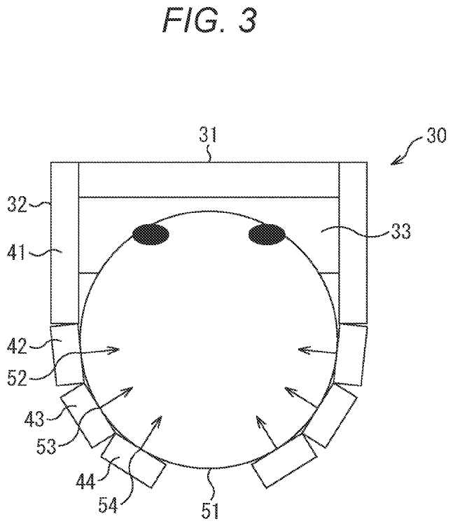

FIG. 3 is a diagram schematically illustrating an external configuration example of an HMD according to a first embodiment of a head mounted device to which the present technology is applied, and is a diagram of a user wearing the HMD as viewed from above.

The HMD 30 in FIG. 3 includes a display 31, a pair of right and left rod-shaped temples 32, and a cushion 33. Specifically, the display 31 is installed between the two temples 32, and the cushion 33 is formed on a mounting surface of the display 31.

The HMD 30 is mounted on a head 51 of the user by each of the two temples 32 being mounted on the left and right of the head 51. Therefore, the display 31 is fixed to the head 51 through the cushion 33. The temple 32 is an articulated temple, and includes a base portion 41, parallel link portions 42 and 43, and a link portion 44. In this case, as illustrated in FIG. 3, the temple 32 can come in close contact with the head 51 at, for example, three points 52 to 54. Therefore, as compared with the HMD 10 of FIG. 1 and the HMD 20 of FIG. 2, a fastening load (holding force) for holding the display 31 can be dispersed. As a result, more comfortable mounting can be realized.

### Detailed Configuration Example of HMD

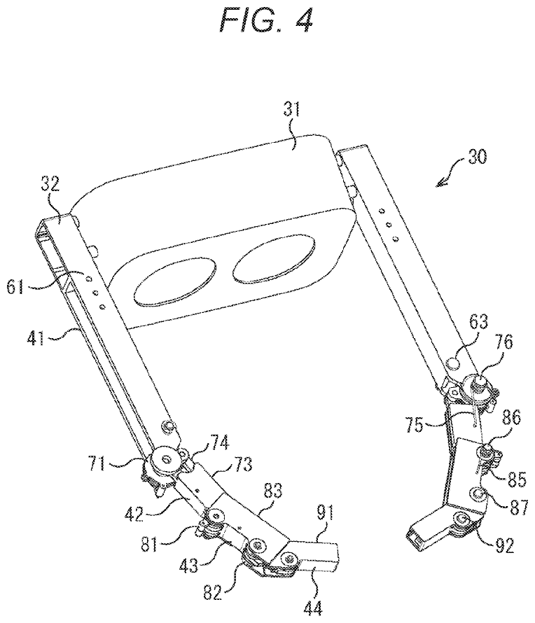

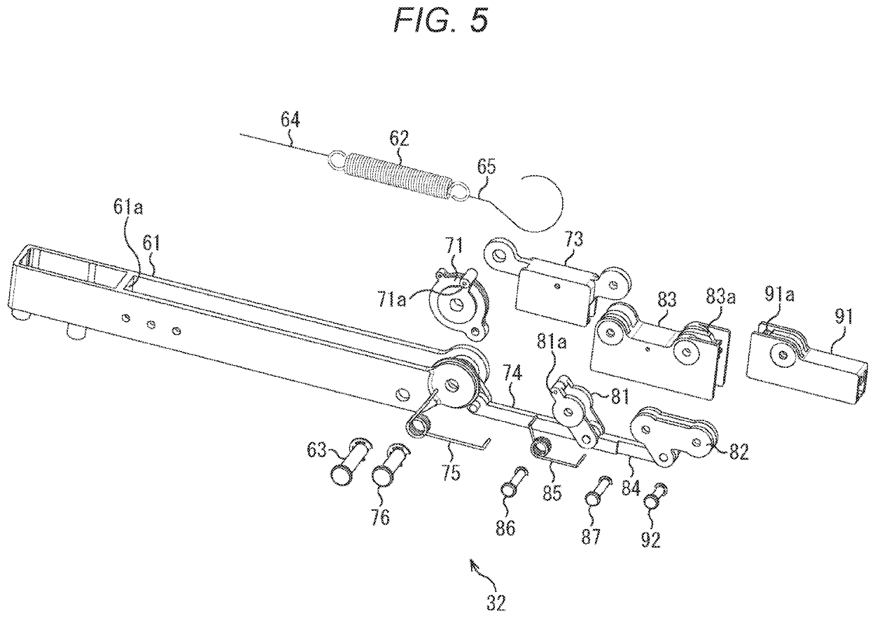

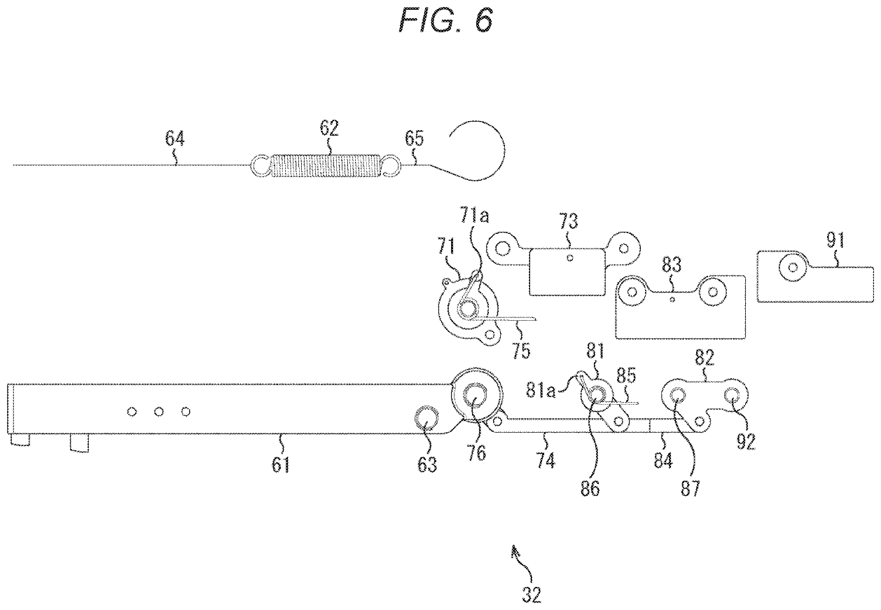

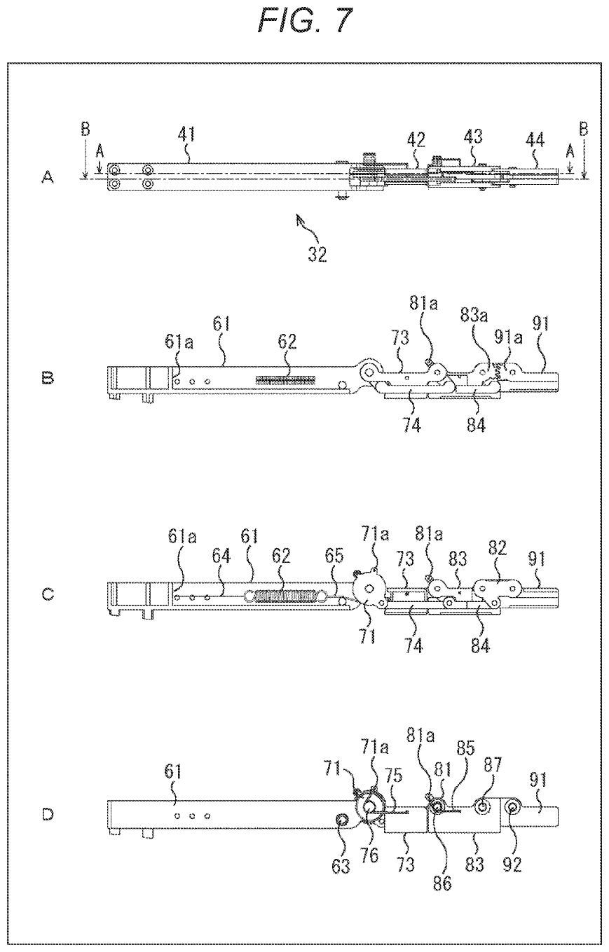

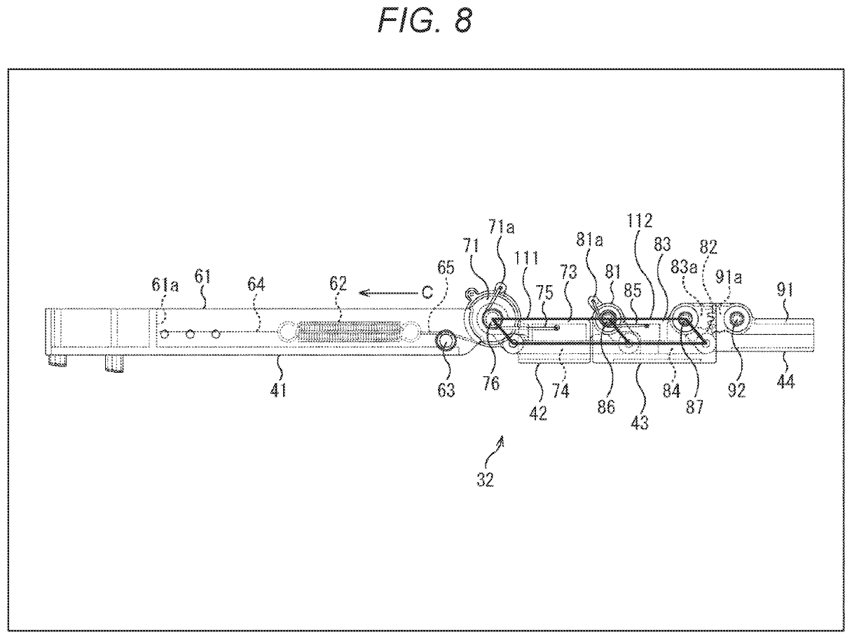

FIG. 4 is a perspective view illustrating a detailed configuration example of the HMD 30 in FIG. 3. Note that, in FIG. 4, the cushion 33 is not illustrated for easy viewing. FIG. 5 is a perspective view when the temple 32 is disassembled, and FIG. 6 is a plan view when the temple 32 is disassembled. FIG. 7 is plan views and cross-sectional views of the temple 32. Specifically, A of FIG. 7 is a plan view of the temple 32 in FIG. 4 as viewed from the inside, B of FIG. 7 is a cross-sectional view taken along line A-A of A of FIG. 7, C of FIG. 7 is a cross-sectional view taken along line B-B of A of FIG. 7, and D of FIG. 7 is a plan view of A of FIG. 7 as viewed from the top. FIG. 8 is a view of the temple 32 on the right side of FIG. 4 as viewed from above, and an internal structure is seen through in FIG. 8.

As illustrated in FIGS. 4 to 8, the base portion 41 of the temple 32 includes a temple base 61, a main spring 62, a guide shaft 63, a wire 64, and a wire 65. The parallel link portion 42 includes links 71, 73, and 74, a torsion spring 75, and a rotation shaft 76. The parallel link portion 43 includes links 81 to 84, a torsion spring 85, a rotation shaft 86, and a rotation shaft 87. The link portion 44 includes a link 91 and a rotation shaft 92.

The temple base 61 of the base portion 41 is rotatably connected to the link 71 and the link 73 (as a joint) through the rotation shaft 76. One end of the main spring 62 is fixed to a main spring fixing portion 61a provided on the display 31 side of the temple base 61 through the wire 64. The other end of the main spring 62 is connected to the link 71 (first link) through the wire 65. The wire 65 extends over the guide shaft 63 towards the link 71.

The link 71 of the parallel link portion 42 has a substantially circular shape, and the wire 65 having one end connected to the main spring 62 is wound thereon. The link 71 fixes the other end of the wire 65. The link 73 is rotatably connected to the temple base 61 and the link 71 through the rotation shaft 76, and is rotatably connected to the link 81 and the link 83 (as a joint) through the rotation shaft 86. The link 74 is rotatably connected to the link 73 so as to be parallel to the link 71, and is rotatably connected to the link 81. The torsion spring 75 is attached to the link 71 through the rotation shaft 76, the rotation shaft 76 being a connection point between the link 71 and the link 73 (third link) as an axis. One end of the torsion spring 75 is fixed (connected) to the torsion spring fixing portion 71a of the link 71, and the other end is fixed (connected) to the link 73.

The link 81 of the parallel link portion 43 is rotatably connected to the link 73 and the link 83 through the rotation shaft 86, and is rotatably connected to the link 84. Note that the link 81 is connected so as to be parallel to the link 71. The link 82 (second link) is rotatably connected to the link 81 (third link) through the rotation shaft 87 (as a joint) so as to be parallel to the link 83, and is rotatably connected to the link 91 (fifth link) through the rotation shaft 92 (as a joint). The link 83 has a gear 83a (first gear) that rotates about the rotation shaft 87. Teeth of the gear 83a mesh with teeth of the gear 91a (second gear) of the link 91. The link 84 is connected to the links 74, 81, and 82 so as to be parallel to the link 83. The torsion spring 85 is attached to the link 81 through the rotation shaft 86, the rotation shaft 86 being a connection point between the link 81 and the link 83 as an axis. One end of the torsion spring 85 is fixed (connected) to the torsion spring fixing portion 81a of the link 81, and the other end is fixed (connected) to the link 83. The gear 91a of the link 91 of the link portion 44 rotates about the rotation shaft 92.

With the above configuration, in the temple 32, as illustrated in FIG. 8, a parallel link mechanism 111 in a (most) preceding stage is configured by the links 71 and 81 parallel to each other and the links 73 and 74 parallel to each other. The links 81 and 82 parallel to each other and the links 83 and 84 parallel to each other configure a parallel link mechanism 112 at a (most) subsequent stage. That is, the temple 32 has two parallel link mechanisms of the parallel link mechanisms 111 and 112. In the parallel link mechanisms 111 and 112 of the two consecutive stages, the link 81 of the preceding parallel link mechanism 111 and the link 81 of the subsequent parallel link mechanism 112 are shared.

In the temple 32, a tensile force in a direction indicated by an arrow C in FIG. 8 is generated in the wire 65 by the main spring 62, so that a torque in a right rotation direction is biased in the rotation shaft 76. As a result, a torque in a direction of rotating the link 73 to the right with respect to the link 71 is biased to the torsion spring 75 attached to the rotation shaft 76. A torque in a direction of rotating the link 73 to the right with respect to the link 81 is applied to the torsion spring 85 attached to the rotation shaft 86 connected to the link 83. A torque in a direction of rotating the link 82 to the right around the rotation shaft 87 is biased to the rotation shaft 87 connected to the link 83. A torque in a direction of rotating the link 91 to the right around the rotation shaft 92 is biased to the rotation shaft 92 connected to the link 82.

### <Description of Temple Operation>

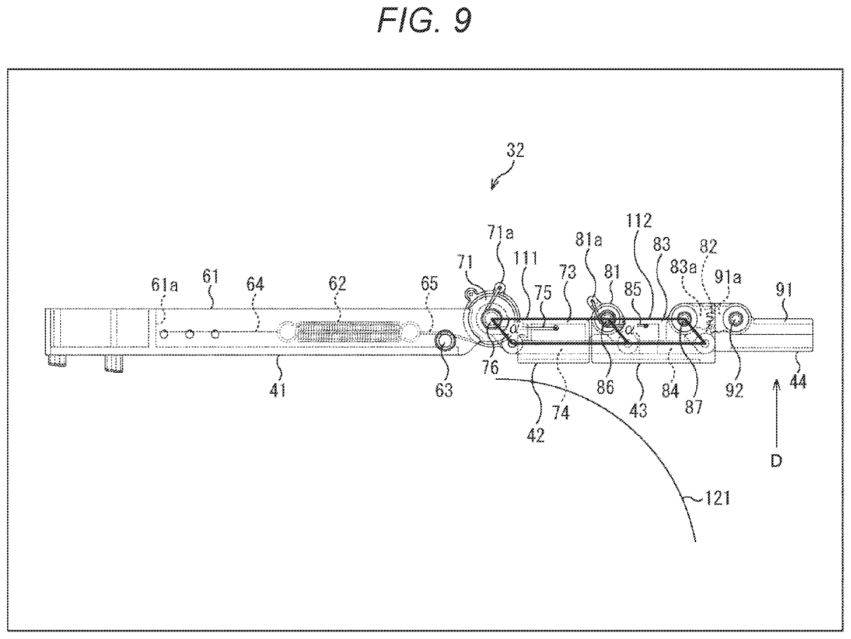

FIGS. 9 to 12 are diagrams illustrating the operation of the temple 32 in a case where the temple 32 is mounted on the head.

FIGS. 9 to 12 are diagrams of the temple 32 on a right side of FIG. 4 as viewed from above, and an internal structure is seen through in FIGS. 9 to 12. In FIGS. 9 to 12, only the mounting of the right-side temple 32 will be described, but the left-side temple 32 is similarly mounted.

In a case where the user wears the temple 32 on a head 121, first, as illustrated in FIG. 9, the user applies a force to a distal end of the link portion 44 with a hand or the like in a direction indicated by an arrow D, that is, in a direction of spreading the temple 32 outward, and holds the distal end. Since the torque by the main spring 62 is canceled by this force, the links 73, 83, and 91 are arranged in series. Therefore, an angle formed by the link 71 and the link 73 and the angle formed by the link 81 and the link 83 are the same angle α. The angle α takes a minimum value due to a biasing force of the torsion springs 75 and 85.

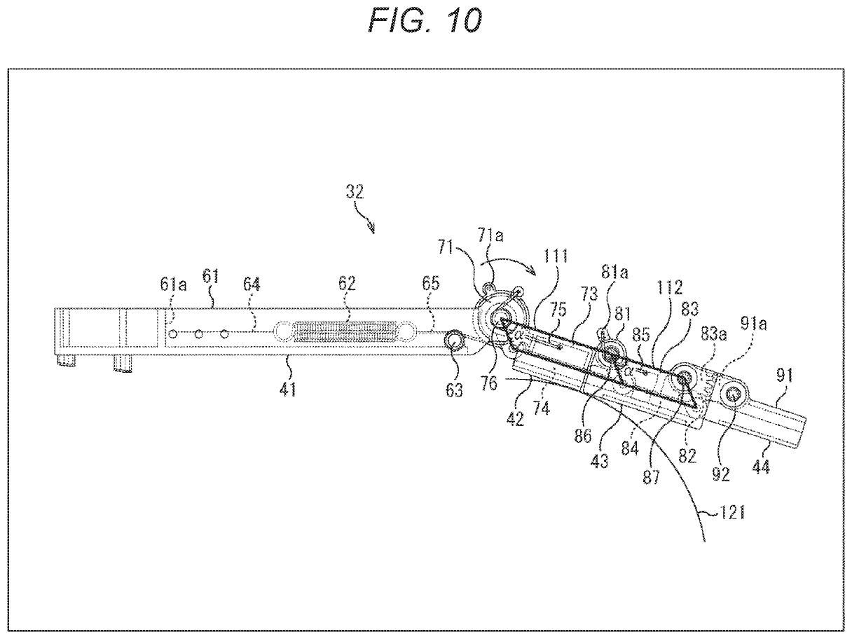

Next, the user reduces a force applied to the link portion 44 in a direction indicated by an arrow D in FIG. 9. As a result, as illustrated in FIG. 10, a torque of the main spring 62 causes the link 71 to start right rotation about the rotation shaft 76. At this time, an angle between the link 71 and the link 73 and an angle between the link 81 and the link 83 remain at the minimum value a due to biasing forces of the torsion springs 75 and 85. Thus, the shapes of the parallel link mechanisms 111 and 112 do not change and the links 73, 83, and 91 remain in series. As described above, the links 73, 83, and 91 start right rotation about the rotation shaft 76. Then, the link 73 comes into contact with the head 121.

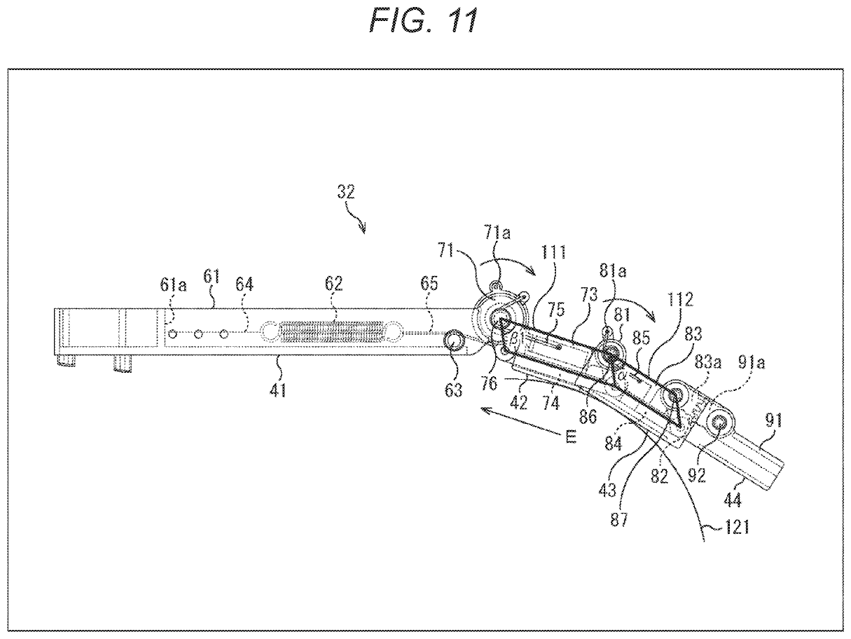

As shown in FIG. 11, the link 73 comes into contact with the head 121, and then the link 73 cannot rotate to the right any more. Therefore, only the link 71 rotates rightward about the rotation shaft 76. Therefore, the angle formed by the link 71 and the link 73 becomes β1 larger than the minimum value a, and the shape of the preceding parallel link mechanism 111 changes. On the other hand, with the right rotation of the link 71, the link 74 connected to the link 71 starts to move in a direction indicated by the arrow E. As the link 74 moves, the link 81 connected to the link 74 starts right rotation about the rotation shaft 86. At this time, an angle formed by the link 81 and the link 83 is maintained at the minimum value a by the biasing force of the torsion spring 85. Therefore, with the rotation of the link 81, the link 83 starts right rotation about the rotation shaft 86 while maintaining a series state of the link 83 and the link 91. That is, the parallel link mechanism 112 in the subsequent stage starts right rotation with respect to the parallel link mechanism 111 in the preceding stage. Then, the link 83 comes into contact with the head 121.

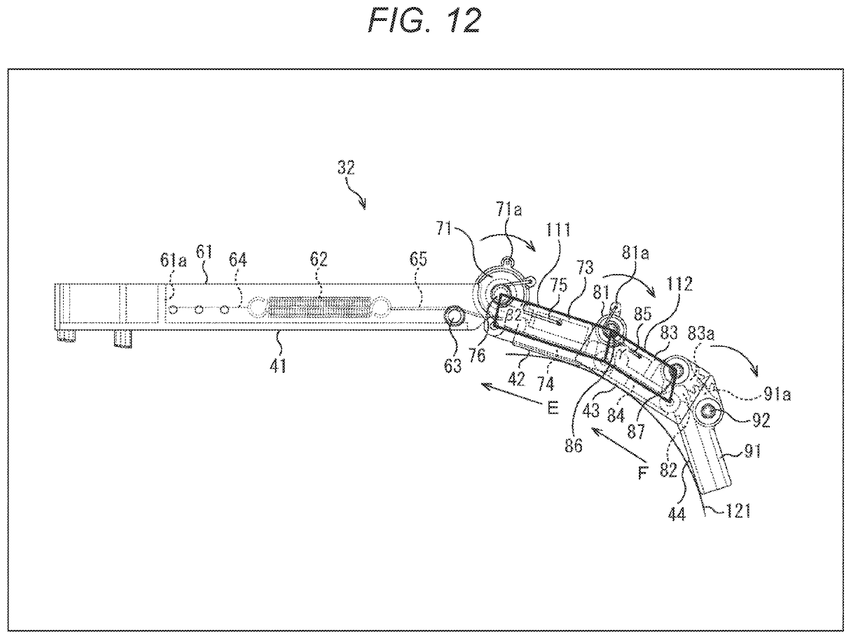

As shown in FIG. 12, the link 83 comes into contact with the head 121, and then the link 83 cannot rotate to the right any more. Therefore, only the link 81 starts right rotation about the rotation shaft 86. Therefore, the angle formed by the link 81 and the link 83 becomes γ larger than the minimum value a, and a shape of the parallel link mechanism 112 in the subsequent stage changes. At this time, with the right rotation of the link 81, the link 74 connected to the link 81 further moves in a direction of an arrow E. Therefore, an angle formed by the link 71 and the link 74 becomes β2 larger than β1, and a shape of the parallel link mechanism 111 also changes.

Along with the right rotation of the link 81, the link 84 connected to the link 81 furthermore starts to move in a direction indicated by an arrow F. As the link 84 moves, the link 82 connected to the link 84 starts right rotation about the rotation shaft 87. Along with the right rotation of the link 82, the link 91 connected to the link 82 also starts right rotation about the rotation shaft 87. At this time, since the link 91 is connected to the gear 83a of the link 83 through the gear 91a, the link 91 also starts right rotation about the rotation shaft 92. Then, the link 91 comes into contact with the head 121.

As described above, the links 73, 83, and 91 of the pair of right and left temples 32 come into contact with the head 121, whereby the mounting of the temple 32 on the head 121, that is, the mounting of the HMD 30 on the head 121 is completed.

In a case where the temple 32 attached to the head 121 is detached as described above, the user applies a force in the direction of the arrow D in FIG. 9 to align the links 73, 83, and 91 in series, thereby detaching the temple 32 from the head 121.

### <Description of Rotation Angle>

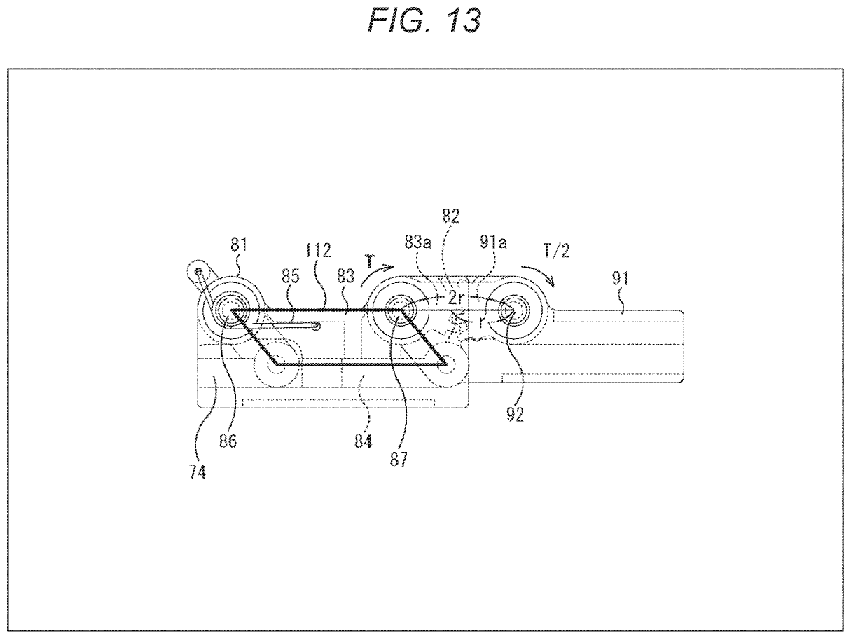

FIG. 13 is a diagram illustrating a rotation angle of the link 82 and the link 91.

As illustrated in FIG. 13, the gear 83a of the link 83 and the gear 91a of the link 91 mesh with each other, and the rotation shaft 87 which is a shaft of the gear 83a and the rotation shaft 92 which is a shaft of the gear 91a are connected by the link 82. Therefore, when the link 82 rotates clockwise about the rotation shaft 87, the link 91 rotates clockwise about the rotation shaft 87 while revolving clockwise around the gear 83a about the rotation shaft 92.

Here, modules and pitch circle diameters of the gear 83a and the gear 91a are the same. The diameters of the gear 83a and the gear 91a are 2r, and then a radius of revolution of the link 91 is 2r whereas a radius of rotation is r. Therefore, a rotation angle of the rotation is twice a rotation angle of the revolution of the link 91. That is, the link 91 rotates at an angle that is twice the rotation angle of the link 82. In a case where the torque (rotation torque) of the link 82 is T, the torque of the link 91 is T/2 that is ½ times the torque of the link 82.

The temple 32 generates a fastening load by converting a tensile force of the main spring 62 into a torque of the link 71. Therefore, the rotation amount of the link 71 increases, and then the tensile force of the main spring 62 decreases, and the fastening load also decreases. As described above, in the temple 32, the link 91 can be rotated at an angle that is twice the rotation angle of the link 82. Therefore, even in a case where the rotation amount of the link 91 increases due to a small size of the user's head or the like, an increase in the rotation amount of the link 71 is suppressed, thereby making it possible to suppress a reduction in the fastening load. As a result, comfortable mounting can be realized regardless of the size of the head or the like. Note that, here, it is assumed that the gear 83a and the gear 91a have the same pitch circle diameter, but the pitch circle diameters may not be the same as long as modules having a value obtained by dividing the pitch circle diameter by the number of teeth are the same.

### <Description of Method of Setting Main Spring and Torsion Spring>

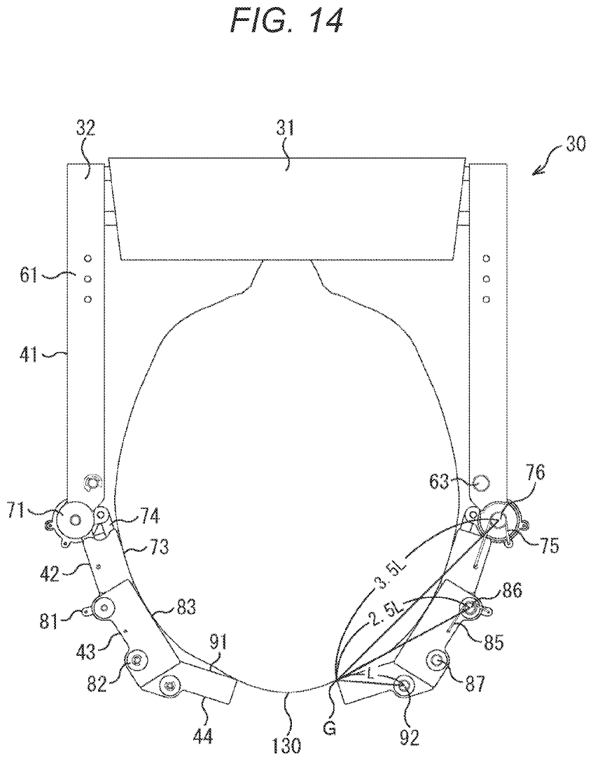

FIG. 14 is a diagram illustrating a method of setting the main spring 62 and the torsion springs 75 and 85, and is a diagram of the head on which the HMD 30 is mounted as viewed from above.

In the setting method of FIG. 14, when the HMD 30 has been mounted, mounting on a head 130 in which the ratio of the distances from the rotation shafts 76, 86, and 92 to a point G at which the link 91 comes into contact with the head 130 is 3.5 L, 2.5 L, and L, respectively, is assumed.

Assuming that a torque generated by the tensile force of the main spring 62 when the HMD 30 is mounted on the head 130 is T1, and torques generated by the torsion springs 75 and 85 are T2 and T3, respectively, a torque of the link 71 on the rotation shaft 76 is T1. After the link 73 has come into contact with the head 130 and stopped, a torque of the link 81 at the rotation shaft 86 transmitted through the link 71 is T1-T2. After the link 83 has come into contact with the head 130 and stopped, a torque of the link 82 at the rotation shaft 87 transmitted through the link 81 is T1-T2-T3. At this time, since the torque of the link 91 is ½ times the torque of the link 82 as described with reference to FIG. 13, a torque of the link 91 on the rotation shaft 92 is (T1-T2-T3)/2.

Here, in order to maintain a state in which the links 73, 83, and 91 are in contact with the head 130 at an angle according to the shape of the head 130 by the rotation of the rotation shafts 76, 86, and 92, that is, in order to bring the links 73, 83, and 91 into close contact with the head 130, forces at the point G by the torque of the links 71, 81, and 91 need to be substantially the same. The force generated in an object by the torque is obtained by “force=torque/radius of rotation” using the radius of rotation, which is a distance from the object to the rotation shaft, and the torque.

As described above, in order for the links 73, 83, and 91 to be in close contact with the head 130 and hold the display 31, a following Expression (1) needs to be established. That is, in the rotation shafts 76, 86, and 92, it is necessary to bias torque proportional to the distance from the rotation shafts 76, 86, and 92 to the point G, respectively.

$$\\ \begin{matrix}[ Math . 1 ] & \\ F 0 = T 1 / 3.5 L \approx ( T 1 - T 2 ) / 2.5 L \approx ( T 1 - T 2 - T 3 ) / 2 L & ( 1 )\end{matrix}$$

In Expression (1), F0 is a fastening load necessary for holding the display 31. Note that, in the experiment, in order to bring the links 73, 83, and 91 into close contact with the head 130, it is found that it is necessary to set a difference between each side of an approximate equation of Expression (1) within about 20% of the fastening load F0.

From Expression (1), a relationship among the torques T1 to T3 is expressed by the following Expression (2).

$$\\ \begin{matrix}[ Math . 2 ] & \\ T 1 \approx 3.5 T 2 \approx 8.75 T 3 & ( 2 )\end{matrix}$$

According to Expression (2), the torques T2 and T3 can be obtained on the basis of the torque T1 and the ratio of the distances from the rotation shafts 76, 86, and 92 to the point G.

A fastening load required to hold the display 31 varies depending on a weight of the HMD 30, a material of the temple 32, a position of the head with which the links 73, 83, and 91 are in contact, and the like. For example, in a case where the weight of the HMD 30 is 200 g, it has been found by experiments that the fastening load F0 is required to be about 2N or more.

In the setting method of FIG. 14, first, the fastening load F0 is determined on the basis of the weight of the HMD 30, the material of the temple 32, the position of the head with which the links 73, 83, and 91 are in contact, and the like. Next, an ideal value of the torque T1 is determined using the fastening load F0 such that the above-described Expression (1) is satisfied. Then, ideal values of the torques T2 and T3 are calculated from the ideal value of the torque T1 according to the above-described Expression (2). The main spring 62 and the torsion springs 75 and 85 are set such that the torques T1 to T3 of the temple 32 are close to the ideal values determined as described above in a case where the HMD 30 is mounted on the assumed head 130.

Note that, in the setting method of FIG. 14, the head 130 in which the ratios of the distances from the rotation shafts 76, 86, and 92 to the point G are 3.5 L, 2.5 L, and L, respectively, when the HMD 30 is mounted is assumed, but this ratio is not limited thereto. This ratio can be, for example, a ratio at the head of various shapes and sizes in which the HMD 30 is assumed to be mounted.

### Example of Measured Value of Torque

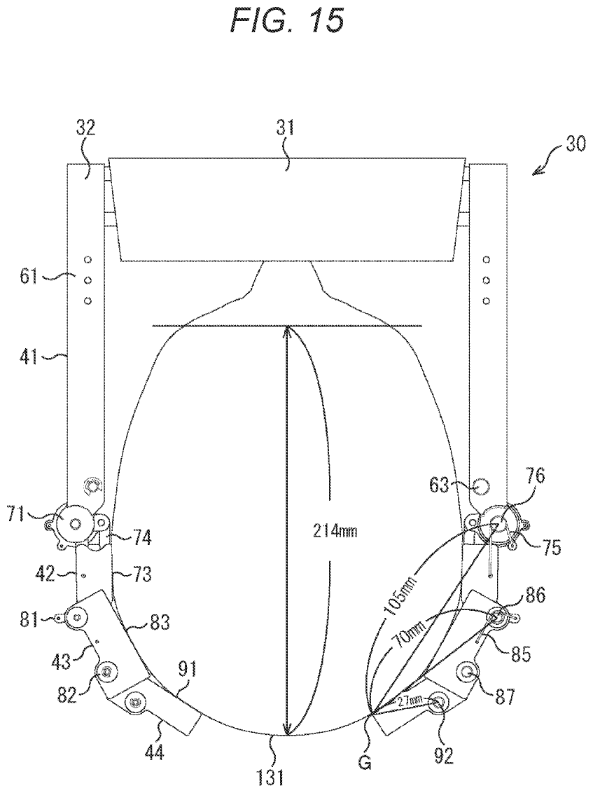

FIGS. 15 to 18 are diagrams illustrating examples of actual measurement values of the torques T1 to T3, and are diagrams of the head on which the HMD 30 is mounted as viewed from above.

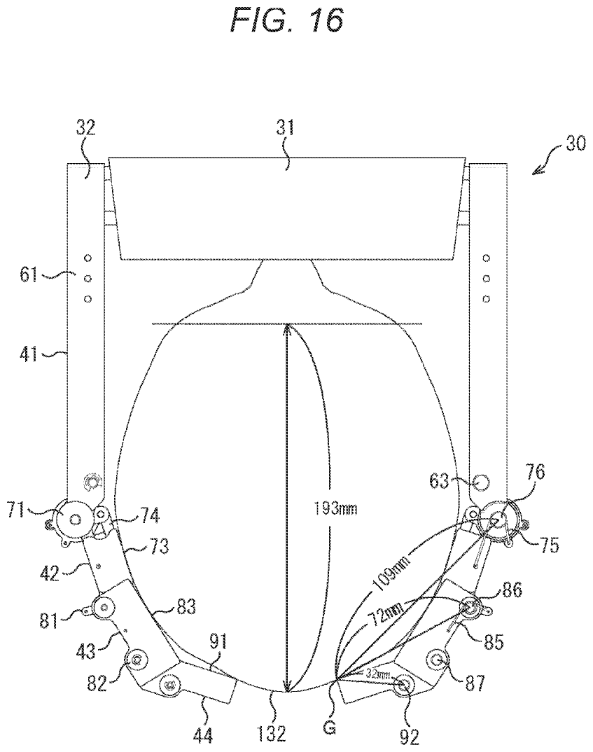

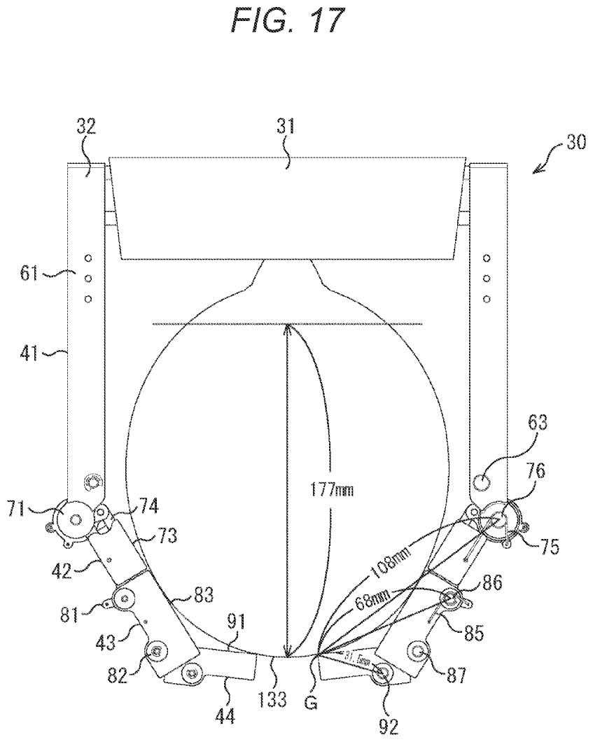

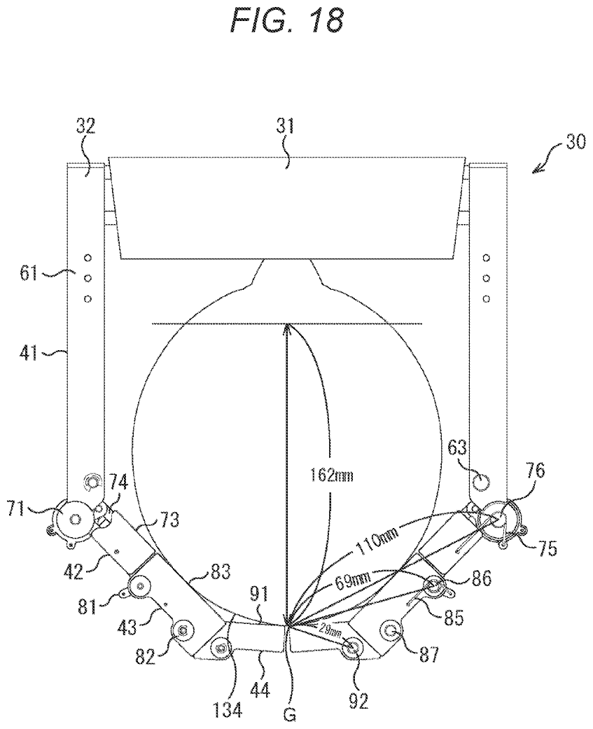

In the example of FIG. 15, the size of a head 131 on which the HMD 30 is mounted is an assumed maximum size, and the size of the head 131 in a front-back direction (the size from a forehead to an occipital region) is 214 mm. In the example of FIG. 16, the size of a head 132 on which the HMD 30 is mounted is a medium size slightly larger than the assumed average value, and the size of the head 132 in the front-back direction is 193 mm. In the example of FIG. 17, the size of a head 133 on which the HMD 30 is mounted is a small size slightly smaller than the assumed average value, and the size of the head 133 in the front-back direction is 177 mm. In the example of FIG. 18, the size of a head 134 on which the HMD 30 is mounted is an assumed minimum size, and the size of the head 134 in the front-back direction is 162 mm.

In the examples of FIGS. 15 to 18, when the links 73, 83, and 91 are arranged in series as shown in FIG. 9, the rotation angle (hereinafter referred to as a torsion angle) of the torsion spring 75 from a position in a free state (state where no force is applied) is 25°, and the torsion angle of the torsion spring 85 is 10°. In the examples of FIGS. 15 to 18, the weight of the HMD 30 is 200 g, and the fastening load F0 is about 2N.

As illustrated in FIGS. 15 to 18, the angles of the links 73, 83, and 91 on the respective rotation shafts 76, 86, and 92 change according to the sizes of the heads 131 to 134 on which the HMD 30 is mounted. Therefore, the positions of the heads 131 to 134 in contact with the respective links 73, 83, and 91 are different depending on the sizes of the heads 131 to 134, and the ratios of the distances from the rotation shafts 76, 86, and 92 to the point G are also different. The tensile force of the main spring 62 is changed by the change in the angle of the link 73 according to the sizes of the heads 131 to 134, the torque T1 generated by the tensile force is changed, and the torque T2 generated by the torsion spring 75 is also changed. The torque T3 generated by the torsion spring 85 changes by the change in the angle of the link 83 according to the sizes of the heads 131 to 134.

For example, as shown in FIG. 15, in a case where the HMD 30 is mounted on the maximum size head 131, the torsion angle of the torsion spring 75 is 67°, and the torsion angle of the torsion spring 85 is 24°. The distances from the rotation shafts 76, 86, and 92 to the point G are 105 mm, 70 mm, and 27 mm, respectively. The torque T1 (measured value) is 255 Nm, the torque T2 (measured value) is 93.8 Nm, and the torque T3 (measured value) is 14.4 Nm. In this case, it is found that when 3.5 L, 2.5 L, and L in the above-described Expression (1) are set to 109 mm, 72 mm, and 32 mm, T1/3.5 L is 2.4 Nm (=255/105), (T1-T2)/2.5 L is 2.3 Nm (=(255-93.8)/70), and (T1-T2-T3)/2 L is 2.7 Nm (=(255-93.8-14.4)/(2×27)). Since T1/3.5 L, (T1-T2)/2.5 L, and (T1-T2-T3)/2 L are substantially the same, the links 73, 83, and 91 are in close contact with the head 131 and share the fastening load. Since the fastening load F0 is 2N or more, the temple 32 can hold the display 31.

As shown in FIG. 16, in a case where the HMD 30 is mounted on the medium size head 132, the torsion angle of the torsion spring 75 is 59°, and the torsion angle of the torsion spring 85 is 30°. The distances from the rotation shafts 76, 86, and 92 to the point G are 109 mm, 72 mm, and 32 mm, respectively. The torque T1 (measured value) is 246 Nm, the torque T2 (measured value) is 82.6 Nm, and the torque T3 (measured value) is 18 Nm. In this case, it is found that when 3.5 L, 2.5 L, and L in the above-described Expression (1) are set to 109 mm, 72 mm, and 32 mm, T1/3.5 L is 2.3 Nm (=246/109), (T1-T2)/2.5 L is 2.3 Nm (=(246-82.6)/72), and (T1-T2-T3)/2 L is 2.3 Nm (=(246-82.6-18)/(2×32)). Since T1/3.5 L, (T1-T2)/2.5 L, and (T1-T2-T3)/2 L are substantially the same, the links 73, 83, and 91 are in close contact with the head 132 and share the fastening load. Since the fastening load F0 is 2N or more, the temple 32 can hold the display 31.

As shown in FIG. 17, in a case where the HMD 30 is mounted on the small-size head 133, the torsion angle of the torsion spring 75 is 51°, and the torsion angle of the torsion spring 85 is 36°. The distances from the rotation shafts 76, 86, and 92 to the point G are 108 mm, 68 mm, and 31.5 mm, respectively. The torque T1 (measured value) is 240 Nm, the torque T2 (measured value) is 71.4 Nm, and the torque T3 (measured value) is 21.6 Nm. In this case, it is found that when 3.5 L, 2.5 L, and L in the above-described Expression (1) are set to 108 mm, 68 mm, and 31.5 mm, T1/3.5 L is 2.2 Nm (=240/108), (T1-T2)/2.5 L is 2.5 Nm (=(240-71.4)/68), and (T1-T2-T3)/2 L is 2.3 Nm (=(240-71.4-21.6)/(2×31.5)). In the example of FIG. 17, the link 73 does not contact the head 133, but since (T1-T2)/2.5 L and (T1-T2-T3)/2 L are substantially the same, the links 83 and 91 are in close contact with the head 133 and share the fastening load. Since the fastening load F0 is 2N or more, the temple 32 can hold the display 31.

As shown in FIG. 18, in a case where the HMD 30 is mounted on the minimum size head 134, the torsion angle of the torsion spring 75 is 46°, and the torsion angle of the torsion spring 85 is 31°. The distances from the rotation shafts 76, 86, and 92 to the point G are 110 mm, 69 mm, and 29 mm, respectively. The torque T1 (measured value) is 232 Nm, the torque T2 (measured value) is 64.4 Nm, and the torque T3 (measured value) is 18.6 Nm. In this case, it is found that when 3.5 L, 2.5 L, and L in the above-described Expression (1) are set to 110 mm, 69 mm, and 29 mm, T1/3.5 L is 2.1 Nm (=232/110), (T1-T2)/2.5 L is 2.4 Nm (=(232-64.4)/69), and (T1-T2-T3)/2 L is 2.6 Nm (=(232-64.4-18.6)/(2×29)). In the example of FIG. 18, the link 73 does not contact the head 133, but since (T1-T2)/2.5 L and (T1-T2-T3)/2 L are substantially the same, the links 83 and 91 are in close contact with the head 134 and share the fastening load. Since the fastening load F0 is 2N or more, the temple 32 can hold the display 31.

Note that, in FIGS. 15 to 18, the case where the size of the head is different has been described, but the similar applies to a case where the shape of the head is different.

As described above, in a case where the main spring 62 and the torsion springs 75 and 85 are set by the setting method described with reference to FIG. 14 so that the links 73, 83, and 91 come into contact with the head, the links 73, 83, and 91 can be brought into close contact with the head. This allows the fastening load needed to hold the display 31 on the head to be distributed across the links 73, 83, and 91. This makes it possible to realize more comfortable mounting and to reduce stress caused by mounting for a long time.

In the temple 32, a fastening load is generated by the torque T1 generated by the tensile force of the main spring 62. Therefore, in the examples of FIGS. 15 and 18, it can be said that the difference in the torque T1 when the HMD 30 is mounted on the head 131 having the maximum size and the head 134 having the minimum size is a difference in the fastening load depending on the sizes of the head 131 and the head 134. Note that in practice, since the position of the point G changes in FIGS. 15 and 18, the difference in the torque T1 and the difference in the fastening load do not completely match due to the difference in the rotation radius, but are considered to be substantially the same. In the examples of FIGS. 15 to 18, the torque T1 of the head 131 is 255 Nm, and the torque T1 of the head 134 is 232 Nm. Therefore, the difference between the fastening load of the head 131 and the fastening load of the head 134 is as small as about 10% of the fastening load of the head 131.

A first reason why the difference between the fastening load of the head 131 and the fastening load of the head 134 becomes small is that since the fastening load is generated using an elastic member such as the main spring 62, the difference in the fastening load due to the size of the head becomes small as compared with a case where the fastening load is generated by bending of a member similarly to a general temple of glasses. A second reason is that, as described with reference to FIG. 13, since the link 91 can be rotated at an angle twice as large as the rotation angle of the link 82, reduction of the fastening load is suppressed even in a case where the size of the user's head is small.

As described above, the temple 32 is configured by connecting the two parallel link mechanisms 111 and 112. Therefore, after the parallel link mechanism 111 in the preceding stage connected to the temple base 61 side (a root side of the temple 32) rotates about the rotation shaft 76 and comes into contact with the head, the rotation of the parallel link mechanism 112 in the subsequent stage about the rotation shaft 86 is started. Therefore, the parallel link mechanism 111 forms an angle along the shape of the head with respect to the temple base 61, and the parallel link mechanism 112 forms an angle along the shape of the head with respect to the parallel link mechanism 111. As a result, the links 73 and 83 can be brought into close contact with the head.

Therefore, a fastening load is generated in the temple 32 in a state where the links 73 and 83 are in close contact with the head, whereby the fastening load can be dispersed in the links 73 and 83. Therefore, even in a case where the HMD 30 is mounted on the head of the user for a long time using the temples 32, pain due to the fastening load is less likely to occur. As described above, the HMD 30 mounted on the head of the user using the temples 32 can realize more comfortable mounting.

### Second Embodiment

### External Configuration Example of HMD

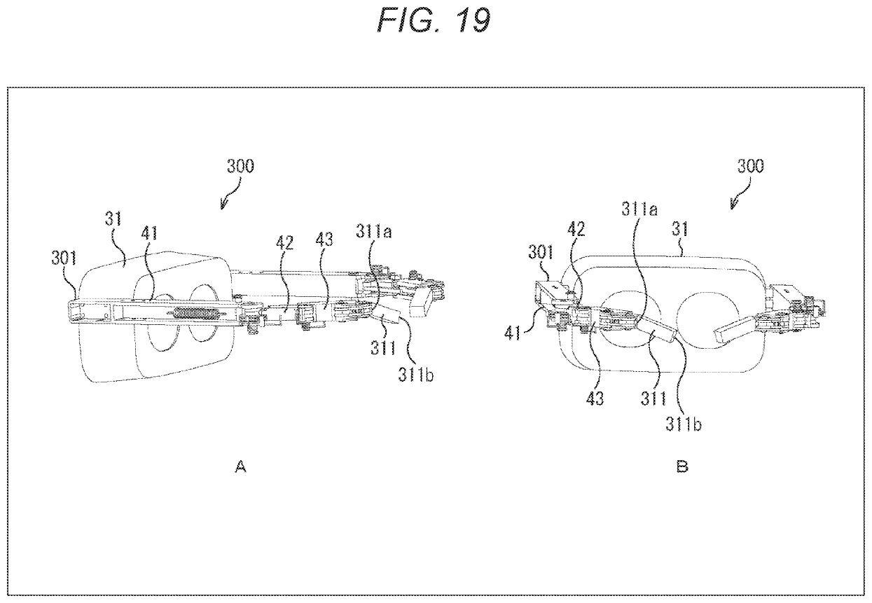

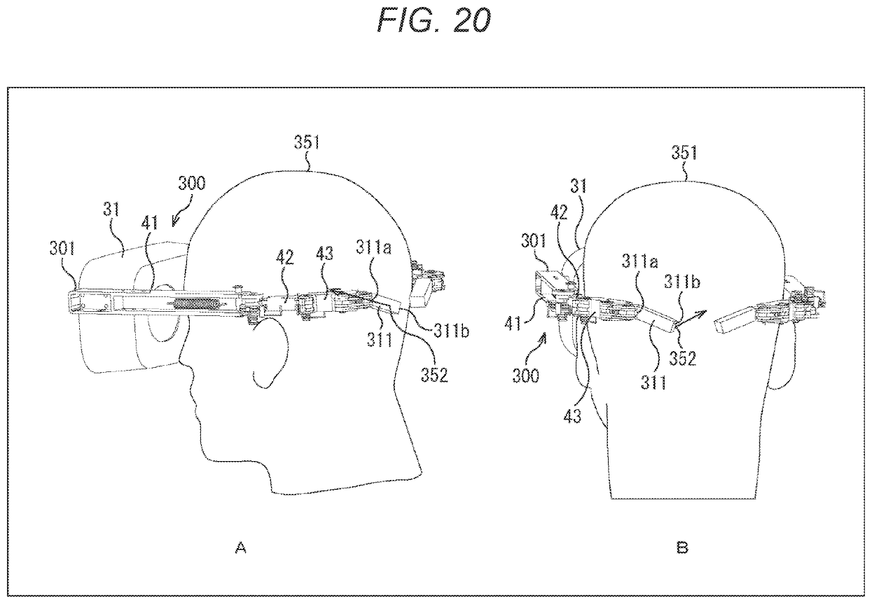

FIGS. 19 and 20 are diagrams illustrating an external configuration example of an HMD according to a second embodiment in a head mounted device to which the present technology is applied.

A of FIG. 19 is a perspective view of an HMD 300 before being mounted on a head 351 as viewed from the back of a temporal region when the HMD 300 is mounted on the head 351 of the user, and B of FIG. 19 is a perspective view of the HMD 300 before being mounted on the head 351 as viewed from an occipital region. A of FIG. 20 is a perspective view of the HMD 300 after being mounted on the head 351 as viewed from the back of the temporal region when the HMD 300 is mounted on the head 351 of the user, and B of FIG. 20 is a perspective view of the HMD 300 after being mounted on the head 351 as viewed from the occipital region.

In the HMD 300 of FIGS. 19 and 20, portions corresponding to those of the HMD 30 in FIG. 3 are denoted by the same reference numerals. Therefore, a description of those portions will be appropriately omitted, and a description will be given focusing on portions different from portions of the HMD 30 The HMD 300 is different from the HMD 30 in that temples 301 are provided instead of the temples 32, and is configured similarly to the HMD 30 in the other portions. The temple 301 is different from the temple 32 in that a link portion 311 is provided instead of the link portion 44, and other portions are configured in the similar manner as the temple 32.

Similarly to the link portion 44, the link portion 311 is configured by a link having a gear and a rotation shaft, but as illustrated in FIGS. 19 and 20, an end portion 311b of the link which is not connected to the parallel link portion 43 is inclined so as to be positioned lower than an end portion 311a connected to the parallel link portion 43. Therefore, a position 352 of the head 351 with which the link portion 311 is in contact can be set to a lower side of the occipital region. As a result, at the position 352, a fastening load can be generated in a direction indicated by an arrow in FIG. 20, that is, in a direction from a lower side to an upper side of the inclination of the occipital region of the head 351, and the stability at the time of mounting the HMD 300 is improved.

### Third Embodiment

### External Configuration Example of HMD

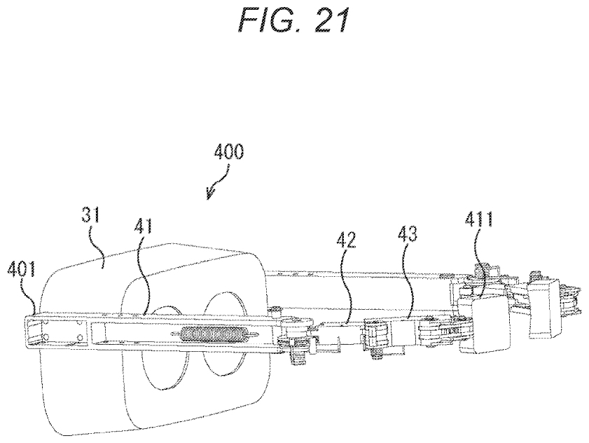

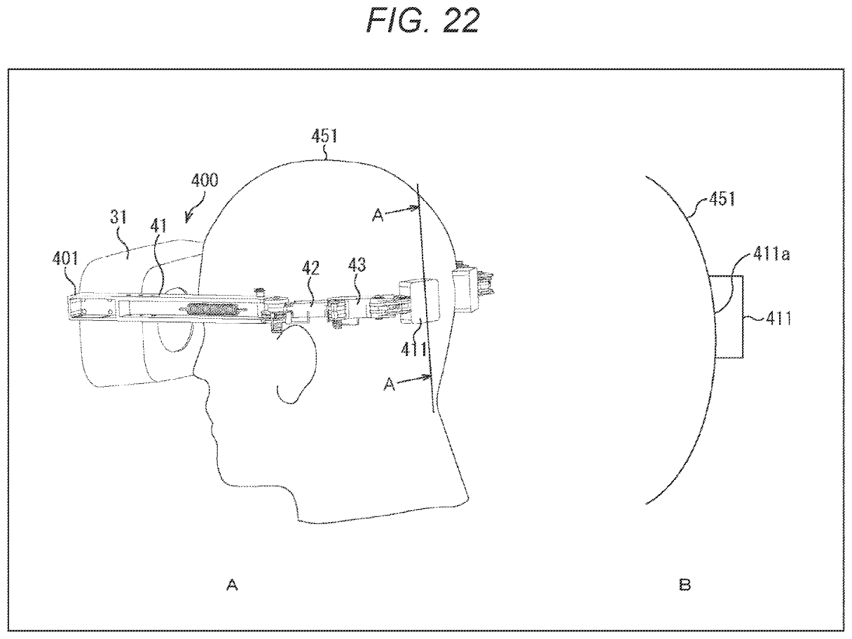

FIGS. 21 and 22 are diagrams illustrating an external configuration example of an HMD according to a third embodiment in a head mounted device to which the present technology is applied.

FIG. 21 is a perspective view of an HMD 400 before being mounted on a head 451 as viewed from the back of a temporal region when the HMD 400 is mounted on the head 451 of the user, and A of FIG. 22 is a perspective view of the HMD 400 after being mounted on the head 451. B of FIG. 22 is a cross-sectional view taken along line A-A of A of FIG. 22.

In the HMD 400 of FIGS. 21 and 22, portions corresponding to those of the HMD 30 in FIG. 3 are denoted by the same reference numerals. Therefore, a description of those portions will be appropriately omitted, and a description will be given focusing on portions different from portions of the HMD 30 The HMD 400 is different from the HMD 30 in that temples 401 are provided instead of the temples 32, and is configured similarly to the HMD 30 in the other portions. The temple 401 is different from the temple 32 in that a link portion 411 is provided instead of the link portion 44, and other portions are configured in the similar manner as the temple 32.

Similarly to the link portion 44, the link portion 411 includes a link having a gear and a rotation shaft, but as illustrated in B of FIG. 22, a surface 411a of the link portion 411 which comes into contact with an occipital region of the head 451 in a case where the temple 401 are mounted on the head 451 is a curved surface. Specifically, the surface 411a of the link portion 411 contains a material that deforms into a shape along a shape of the occipital region when contacting the occipital region, such as a low repulsion cushion. Therefore, the shape of the link portion 411 viewed from above the head 451 on which the temples 401 are mounted are an arch shape along the shape of the occipital region. The area of the surface 411a is equal to or larger than a predetermined area, and as illustrated in A of FIG. 21 and FIG. 22, a vertical width of the link portion 411 is wider than that of the link portion 44.

As described above, since the surface 411a of the link portion 411 is deformed into a shape conforming to the shape of the occipital region of the head 451, the link portion 411 is in closer contact with (fits to) the head 451. As a result, the stability at the time of mounting the HMD 400 is improved.

### Fourth Embodiment

### External Configuration Example of HMD

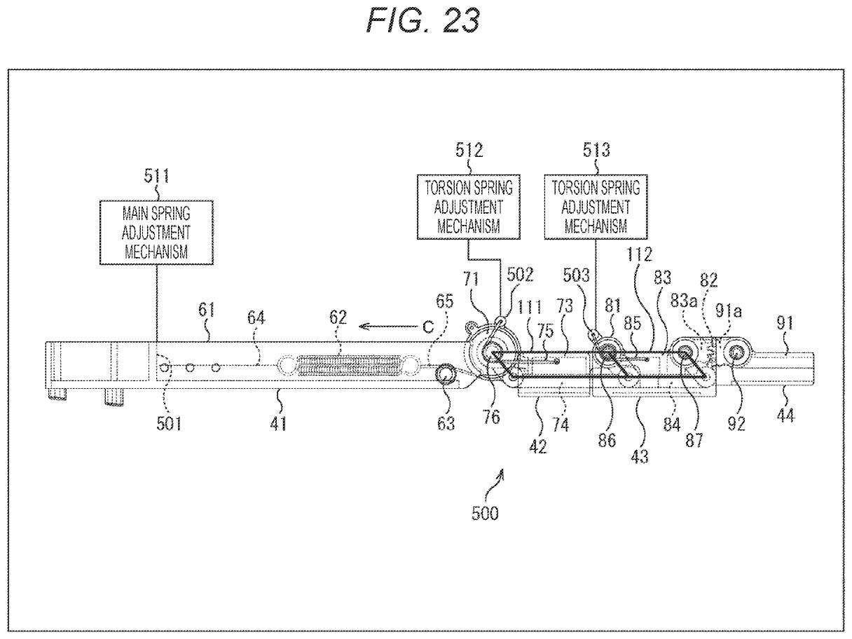

FIG. 23 is a diagram illustrating an external configuration example of a temple mounted on a right side of a head of a user in an HMD according to a fourth embodiment of the head mounted device to which the present technology is applied, and is a diagram of the temple viewed from above. In FIG. 23, an internal structure is seen through.

Note that each portion other than the temple in the HMD according to the fourth embodiment is configured similarly to the HMD 30.

In a temple 500 of FIG. 23, portions corresponding to those of the temple 32 of FIG. 8 are denoted by the same reference numerals. Therefore, a description of those portions will be appropriately omitted, and a description will be given focusing on portions different from portions of the temple 32.

The temple 500 is different from the temple 32 in that a main spring fixing portion 501, a torsion spring fixing portion 502, and a torsion spring fixing portion 503 are provided instead of the main spring fixing portion 61a, the torsion spring fixing portion 71a, and the torsion spring fixing portion 81a, and that a main spring adjustment mechanism 511 and torsion spring adjustment mechanisms 512 and 513 are newly provided. The other configurations are similar to those of the temple 32.

The main spring fixing portion 501 is provided on the temple base 61 similarly to the main spring fixing portion 61a, and fixes one end of the main spring 62. The main spring fixing portion 501 is configured to be movable in a left-right direction in the drawing by the main spring adjustment mechanism 511. The torsion spring fixing portion 502 is provided on the link 71 similarly to the torsion spring fixing portion 71a, and fixes one end of the torsion spring 75. The torsion spring fixing portion 502 is configured to be movable in a circumferential direction of the link 71 by the torsion spring adjustment mechanism 512. The torsion spring fixing portion 503 is provided on the link 81 similarly to the torsion spring fixing portion 81a, and fixes one end of the torsion spring 85. The torsion spring fixing portion 503 is configured to be movable in the circumferential direction of the link 81 by the torsion spring adjustment mechanism 513.

The main spring adjustment mechanism 511 includes a dial (not illustrated), and adjusts a position of the main spring fixing portion 501 according to the operation of the dial by the user. The torsion spring adjustment mechanism 512 has a dial (not illustrated), and adjusts a position of the torsion spring fixing portion 502 according to the operation of the dial by the user. The torsion spring adjustment mechanism 513 has a dial (not illustrated), and adjusts a position of the torsion spring fixing portion 503 according to the operation of the dial by the user.

As described above, since the temple 500 has the main spring adjustment mechanism 511, the user can adjust the position of the main spring fixing portion 501 using the main spring adjustment mechanism 511. Therefore, the user can adjust the torque T1 generated by the main spring 62 and generate a desired fastening load. Furthermore, the temple 500 has the torsion spring adjustment mechanisms 512 and 513, so that the user can adjust the torque T2 of the torsion spring 75 and the torque T3 of the torsion spring 85. Therefore, even in a case where the shape and size of the head 130 assumed at the time of setting the torsion springs 75 and 85 are different from the shape and size of the head on which the temple 500 is actually mounted, the user can bring the links 73, 83, and 91 into close contact with the head by adjusting the torques T2 and T3.

### Fifth Embodiment

### External Configuration Example of HMD

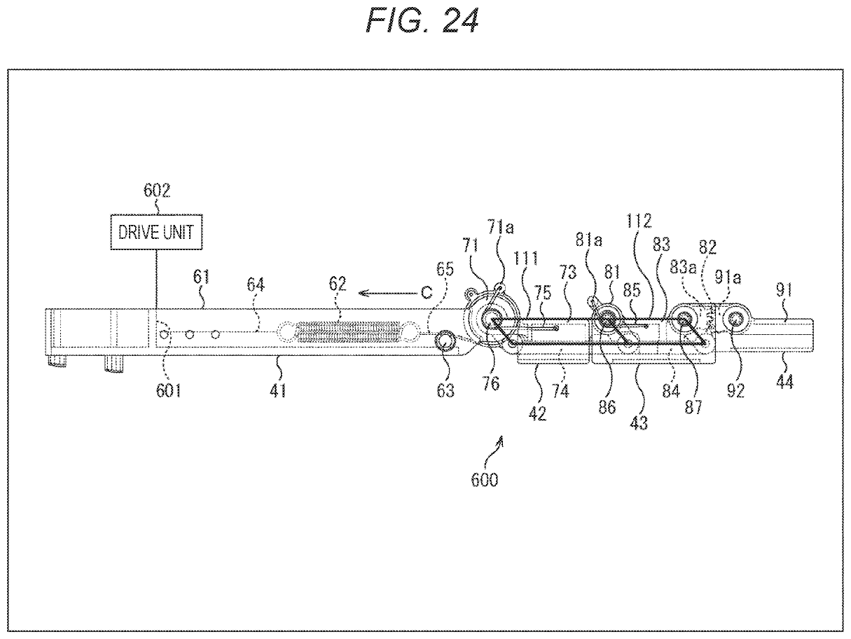

FIG. 24 is a diagram illustrating an external configuration example of a temple mounted on a right side of a head of a user in an HMD according to a fifth embodiment of a head mounted device to which the present technology is applied, and is a diagram of the temple viewed from above. In FIG. 24, an internal structure is seen through.

Note that each portion other than the temple in the HMD according to the fifth embodiment is configured similarly to the HMD 30.

In a temple 600 of FIG. 24, portions corresponding to those of the temple 32 of FIG. 8 are denoted by the same reference numerals. Therefore, a description of those portions will be appropriately omitted, and a description will be given focusing on portions different from portions of the temple 32.

The temple 600 is different from the temple 32 in that a main spring fixing portion 601 is provided instead of the main spring fixing portion 61a and that a drive unit 602 is newly provided, and is configured in the similar manner as the temple 32 except for this point.

The main spring fixing portion 601 is provided on the temple base 61 similarly to the main spring fixing portion 61a, and fixes one end of the main spring 62. The main spring fixing portion 601 is configured to be movable in the left-right direction in the drawing by the drive unit 602. A rightmost position (hereinafter referred to as a first position) of a movable range of the main spring fixing portion 601 is a position where no tensile force is generated in the main spring 62. A leftmost position (hereinafter referred to as a second position) is a position where a torque of the main spring 62 is close to the ideal value of the torque T1 calculated as described in FIG. 14. An initial position of the main spring fixing portion 601 is the first position.

The drive unit 602 includes a drive device such as a motor, and includes a switch (not illustrated). The drive unit 602 drives the main spring fixing portion 601 according to operation on a switch by the user, and moves it from one of the first position and the second position to the other.

As described above, since the temple 600 includes the drive unit 602 that drives the main spring fixing portion 601, the user does not need to apply and hold a force with a hand or the like in a direction of spreading the temple 600 outward as described with reference to FIG. 9 when mounting the temple 600.

Specifically, before the temple 32 is mounted, the switch of the drive unit 602 is turned off, and the main spring fixing portion 601 is disposed at the first position which is the initial position. Therefore, the links 73, 83, and 91 are arranged in series, and the user does not need to apply a force by hand or the like in a direction of spreading the temple 600 outward as described with reference to FIG. 9. When mounting the temple 32, the user operates the switch of the drive unit 602 to turn on, and moves the main spring fixing portion 601 to the second position. Therefore, the torque T1 is generated in the main spring 62, and the temple 32 operates as described with reference to FIGS. 10 to 12. Therefore, the temple 600 is mounted on the head of the user.

In a case where the temple 600 mounted on the head is removed, the user turns off the switch of the drive unit 602 and moves the main spring fixing portion 601 to the first position. Therefore, the links 73, 83, and 91 are arranged in series, and the temple 600 is separated from the head.

### Sixth Embodiment

### External Configuration Example of HMD

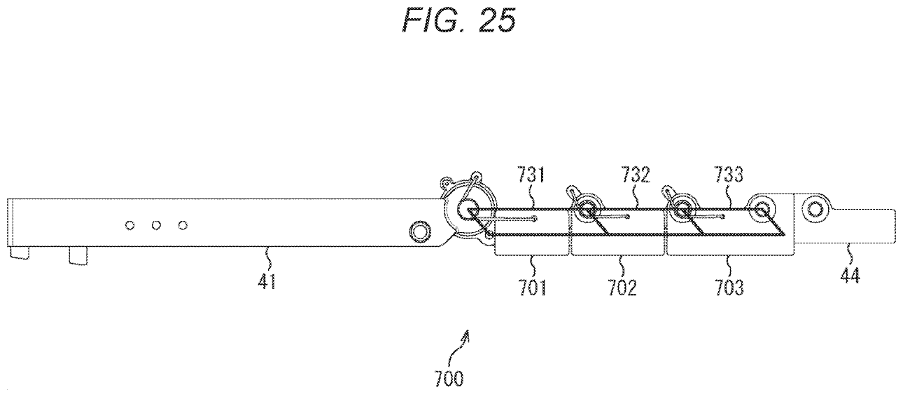

FIG. 25 is a diagram illustrating an external configuration example of a temple mounted on a right side of a head of a user in an HMD according to a sixth embodiment of a head mounted device to which the present technology is applied, and is a diagram of the temple viewed from above.

Note that each portion other than the temple in the HMD according to the sixth embodiment is configured similarly to the HMD 30.

In a temple 700 of FIG. 25, portions corresponding to those of the temple 32 of FIG. 8 are denoted by the same reference numerals. Therefore, a description of those portions will be appropriately omitted, and a description will be given focusing on portions different from portions of the temple 32.

The temple 700 is different from the temple 32 in that three parallel link portions 701 to 703 are provided instead of the parallel link portion 42 and the parallel link portion 43, and other portions are configured in the similar manner as the temple 32.

The parallel link portion 701 is configured similarly to the parallel link portion 42, but is connected to the parallel link portion 702 instead of the parallel link portion 43. The parallel link portion 702 is configured similarly to the parallel link portion 42 except for no connection to the main spring 62. The parallel link portion 702 is connected to the parallel link portions 701 and 703. The parallel link portion 703 is configured similarly to the parallel link portion 43, but is connected to the parallel link portion 702 instead of the parallel link portion 42.

With the above configuration, the temple 700 has three stages of parallel link mechanisms 731 to 733. The parallel link mechanism 731 includes three links of the parallel link portion 701 and one link of the parallel link portion 702. The parallel link mechanism 732 includes three links of the parallel link portion 702 and one link of the parallel link portion 703. The parallel link mechanism 733 includes four links of the parallel link portion 703. That is, the parallel link mechanisms 731 and 732 of the two consecutive stages share one link similarly to the parallel link mechanisms 111 and 112. Similarly to the parallel link mechanisms 111 and 112, one link is shared between the two consecutive stages of the parallel link mechanisms 732 and 733.

As described above, since the temple 700 has the three parallel link mechanisms 731 to 733, a total of four points of the three parallel link portions 701 to 703 and the link portion 44 can be brought into contact with the head when the temple is mounted on the head of the user. As a result, the fastening load can be further dispersed. Note that the expression of the condition necessary for the three parallel link portions 701 to 703 and the link portion 44 to be in close contact with the head is obtained by adding four expressions regarding the torque in the above-described Expression (1).

Although not illustrated, the number of parallel link mechanisms can be further increased similarly to the temple 700. That is, the parallel link mechanism of the temple may have any number of stages as long as it has two or more stages.

### Seventh Embodiment

### Configuration Example of Head Mounted Camera

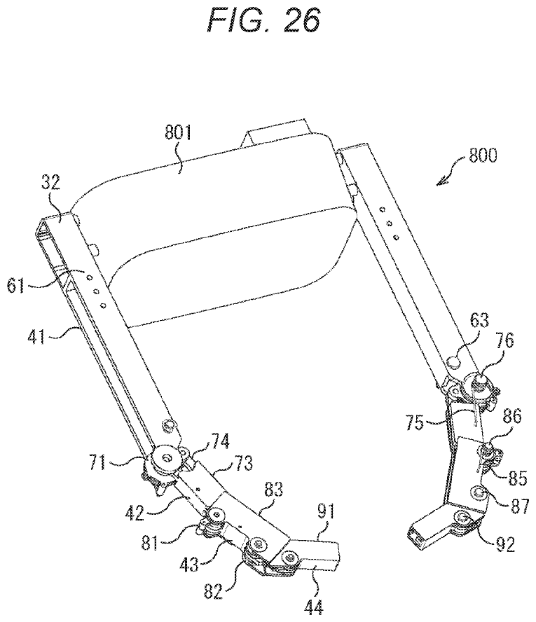

FIG. 26 is a perspective view illustrating an external configuration example of a head mounted camera according to a seventh embodiment of the head mounted device to which the present technology is applied.

In the head mounted camera 800 of FIG. 26, portions corresponding to those of the HMD 30 of FIG. 4 are denoted by the same reference numerals. Therefore, a description of those portions will be appropriately omitted, and a description will be given focusing on portions different from portions of the HMD 30

A head mounted camera 800 is different from the HMD 30 in that a wearable camera 801 is provided instead of the display 31, and other configurations are similar to those of the HMD 30. That is, in the head mounted camera 800, the wearable camera 801 is installed between the two temples 32 instead of the display 31.

The embodiment of the present technology is not restricted to the embodiments described above, and various modifications can be made without departing from the spirit of the present technology.

For example, a form in which all or some of the plurality of embodiments described above are combined can be adopted. The present technology can also be applied to a head mounted device in which various devices other than a display and a camera are mounted on the head.

Note that, the effects described in the present specification are merely examples and are not limited, and there may be effects other than those described in the present specification.

The present technology can have the following configurations.

(1)

A head mounted device including:
two temples to be mounted on a head of a user, in which
the temples include a plurality of stages of parallel link mechanisms each including a first link and a second link parallel to each other, and a third link and a fourth link parallel to each other, and
in the parallel link mechanisms of the two consecutive stages, the second link of the parallel link mechanism in a preceding stage and the first link of the parallel link mechanism in a subsequent stage are shared, and the parallel link mechanism in the subsequent stage rotates with respect to the parallel link mechanism in the preceding stage in a case where the parallel link mechanism in the preceding stage comes into contact with the head.

(2)

The head mounted device according to the above (1), in which
the first link includes a torsion spring having a connection point between the first link and the third link as an axis,
one end of the torsion spring is connected to the first link, and the other end is connected to the third link, and
in the parallel link mechanisms of the two consecutive stages, in a case where the parallel link mechanism of the preceding stage comes into contact with the head, the parallel link mechanism of the subsequent stage rotates with respect to the parallel link mechanism of the preceding stage by rotating the third link of the parallel link mechanism in the subsequent stage about the connection point as an axis.

(3)

The head mounted device according to the above (2),
further including
a torsion spring adjustment mechanism that adjusts a position of a torsion spring fixing portion that fixes one end of the torsion spring.

(4)

The head mounted device according to the above (2) or (3), in which
one end of a main spring is connected to the first link of the parallel link mechanism in a first stage, and
the main spring rotates the first link of the parallel link mechanism in the first stage.

(5)

The head mounted device according to the above (4), further including
a main spring adjustment mechanism that adjusts a position of a main spring fixing portion that fixes the other end of the main spring.

(6)

The head mounted device according to the above (4),
further including
a drive unit that drives a main spring fixing portion that fixes the other end of the main spring.

(7)

The head mounted device according to any one of the above (1) to (6), in which
the second link of the parallel link mechanism in the last stage is connected with a fifth link and the third link of the parallel link mechanism in the last stage,
the third link of the parallel link mechanism in the last stage includes a first gear,
the fifth link includes a second gear whose module is the same as that of the first gear, and
the first gear and the second gear mesh with each other.

(8)

The head mounted device according to any one of the above (1) to (6), in which
the second link of the parallel link mechanism in a last stage is connected with one end of a fifth link, and
the other end of the fifth link is positioned lower than the one end of the fifth link.

(9)

The head mounted device according to any one of the above (1) to (6), in which
the second link of the parallel link mechanism in the last stage is connected with a fifth link, and
a surface of the fifth link that comes into contact with the head in a case where the temple is mounted on the head is a curved surface.

(10)

The head mounted device according to the above (9), in which
an area of the surface is a predetermined area or more.

(11)

The head mounted device according to any one of the above (1) to (10),
further including
a display installed between the two temples.

(12)

The head mounted device according to any one of the above (1) to (10),
further including
a camera installed between the two temples.

### REFERENCE SIGNS LIST

30 HMD
31 Display
32 Temple
51 Head
61a Main spring fixing portion
62 Main spring
71 Link
71a Torsion spring fixing portion
73, 74 Link
75 Torsion spring
76 Rotation shaft
81 Link
81a Torsion spring fixing portion
82, 83 Link
83a Gear
84 Link
85 Torsion spring
86 Rotation shaft
91 Link
91a Gear
111, 112 Parallel link mechanism
121 Head
130 to 134 Head
300 HMD
301 Temple
311 Link portion
311a, 311b End portion
351 Head
400 HMD
401 Temple
411 Link portion
411a Surface
451 Head
500 Temple
501 Main spring fixing portion
502, 503 Torsion spring fixing portion
511 Main spring adjustment mechanism
512, 513 Torsion spring adjustment mechanism
600 Temple
601 Main spring fixing portion
602 Drive unit
700 Temple
731 to 733 Parallel link mechanism
800 Head mounted camera
801 Wearable camera

1. A head mounted device comprising:
two temples to be mounted on a head of a user, wherein
the temples include a plurality of stages of parallel link mechanisms each including a first link and a second link parallel to each other, and a third link and a fourth link parallel to each other, and
in the parallel link mechanisms of the two consecutive stages, the second link of the parallel link mechanism in a preceding stage and the first link of the parallel link mechanism in a subsequent stage are shared, and the parallel link mechanism in the subsequent stage rotates with respect to the parallel link mechanism in the preceding stage in a case where the parallel link mechanism in the preceding stage comes into contact with the head.

2. The head mounted device according to claim 1, wherein
the first link includes a torsion spring having a connection point between the first link and the third link as an axis,
one end of the torsion spring is connected to the first link, and the other end is connected to the third link, and
in the parallel link mechanisms of the two consecutive stages, in a case where the parallel link mechanism of the preceding stage comes into contact with the head, the parallel link mechanism of the subsequent stage rotates with respect to the parallel link mechanism of the preceding stage by rotating the third link of the parallel link mechanism in the subsequent stage about the connection point as an axis.

3. The head mounted device according to claim 2,
further comprising
a torsion spring adjustment mechanism that adjusts a position of a torsion spring fixing portion that fixes one end of the torsion spring.

4. The head mounted device according to claim 2, wherein
one end of a main spring is connected to the first link of the parallel link mechanism in a first stage, and
the main spring rotates the first link of the parallel link mechanism in the first stage.

5. The head mounted device according to claim 4,
further comprising
a main spring adjustment mechanism that adjusts a position of a main spring fixing portion that fixes the other end of the main spring.

6. The head mounted device according to claim 4,
further comprising
a drive unit that drives a main spring fixing portion that fixes the other end of the main spring.

7. The head mounted device according to claim 1, wherein
the second link of the parallel link mechanism in the last stage is connected with a fifth link and the third link of the parallel link mechanism in the last stage,
the third link of the parallel link mechanism in the last stage includes a first gear,
the fifth link includes a second gear whose module is the same as that of the first gear, and
the first gear and the second gear mesh with each other.

8. The head mounted device according to claim 1, wherein
the second link of the parallel link mechanism in a last stage is connected with one end of a fifth link, and
the other end of the fifth link is positioned lower than the one end of the fifth link.

9. The head mounted device according to claim 1, wherein
the second link of the parallel link mechanism in the last stage is connected with a fifth link, and
a surface of the fifth link that comes into contact with the head in a case where the temple is mounted on the head is a curved surface.

10. The head mounted device according to claim 9, wherein
an area of the surface is a predetermined area or more.

11. The head mounted device according to claim 1,
further comprising
a display installed between the two temples.

12. The head mounted device according to claim 1,
further comprising
a camera installed between the two temples.
